(19) United States
(12) Patent Application Publication
(10) Pub. No.: US 2007/0164566 A1
(43) Pub. Date: Jul. 19, 2007

(54) Lockwireless coupling assembly

(76) Inventor: Nilesh Patel, Irvine, CA (US)

Correspondence Address: James M. Duncan;Klein, DeNatale, Goldner, Cooper,, Rosenlieb & Kimball, LLP, P.O. Box 11172, Bakersfield, CA, 93389-1172, US

(21) Appl. No.: 11/655,758

(22) Filed: Jan. 19, 2007

Related U.S. Application Data
(60) Provisional application No. 60/760,100, filed on Jan. 19, 2006.

(51) Int. Cl. F16L 25/00

(52) U.S. Cl. 285/386

(57) ABSTRACT

A self-locking fluid coupling, utilized to connect two fluid conduits together, does not require the lockwiring of the coupling nut to prevent the rotation of the coupling nut. The locking mechanism comprises a rotational locking means on a ferrule member. The rotational locking means engage one or more inwardly protruding engagement members of the B-nut. The engagement of the rotational locking means of the ferrule with the engagement members of the B-nut creates resistance to circular motion, thereby resisting rotation of the B-nut and eliminating the requirement for lockwire to resist rotation of the B-nut.

### CROSS-REFERENCE TO RELATED APPLICATION

U.S. Provisional Application No. 60/760,100 for this invention was filed on Jan. 19, 2006 for which the inventor claims domestic priority.

### BACKGROUND OF THE INVENTION

The present invention is broadly directed to a locking assembly for fastening two fluid-transmitting conduits together and, more particularly, to an improved fluid coupling assembly for providing a compression sealed joint that can maintain its preload characteristics without the utilization of lock wire or other externally applied devices or chemical compositions.

Numerous devices have been utilized to retain the mechanical coupling of fluid-transmitting conduits during use. As is well known, application of stress, vibration, movement, etc. to a coupled connection can cause a loosening and release of a desired seating torque between a pair of fluid-transmitting conduits which have been coupled together. A typical method of connecting two adjacent fluid-transmitting conduits is to utilize a threaded coupling, wherein each respective end of the conduit is attached to a component of the coupling apparatus. The seals of the coupling apparatus are thereafter preloaded by making up the threaded connection between the components of the coupling. However, it is known that various phenomena such as vibration, flexing, or other cyclical or dynamic loading can cause such couplings to work loose potentially resulting in fluid release. Numerous methods and apparatus have been utilized to inhibit the loosening of the coupling after it has been preloaded, including lockwire and adhesive materials have been used to prevent the loosening of the coupling.

The loosening of the connection can be a particular problem for pneumatic and hydraulic connectors, which are not only subjected to external vibrations and stresses, but also subjected to internal pressure stresses from the fluid that is being conducted through the sealed joint. In past practice in the aircraft industry, a substantial number of fluid coupling joints have consisted of compression fittings secured together with threaded connections, where a nut is lock wired to a mating connecting component in such a manner that the nut cannot turn with respect to the fitting to ensure against loss of fluid tightness in the sealing joint. However, fluid coupling joints are frequently located in areas where vision can be obscured, and the assembling of the joints must be made out of the direct vision of the worker. In such events, lock wiring is an unsatisfactory means of securing the joint against subsequent loosening. As can also be appreciated, inspection of the joint to ensure its integrity is often compromised. In addition, the lock wiring process can be time consuming. It usually requires drilling a hole in one or more corners of the nut (referred to as B-nut in hydraulic and pneumatic applications) and securing the wire to a boss or other tie-down structure to secure the tie-wire. Moreover, the lock wired connection can cause damage to equipment, and injury to personnel because of the twisted wire ends which easily snag on fabric, equipment, and skin.

While various other lockwireless coupling assemblies have been disclosed, many of these require multiple or complicated parts to achieve the locking of the connection. Many of these assemblies provide for a lock between the connector and the B-nut. The connector length typically has to be increased to incorporate the locking feature. The increased length of the connector results in increased weight of the coupling, and can also complicate the installation where space is limited.

### SUMMARY OF THE INVENTION

The present invention is directed to a self-locking fluid coupling which eliminates the need for lockwiring the coupling nut while providing ease of installation and good torque resistance, and without requiring detachable locking mechanisms such as locking clips or pins or requiring special tools for assembly. The coupling is utilized to connect two fluid conduits together. An internal ferrule member comprises means for preventing the rotation of the nut member of the coupling once the nut member has been made up in sealing engagement with the connector. Among other forms of rotational locking mechanisms, the means for preventing the rotation of the nut member may comprise a plurality of serrations on the ferrule member wherein one or more of the serrations are engaged by complimentary locking means in the nut member, such as one or more inwardly protruding engagement members. The engagement of the serrations of the ferrule with the engagement members of the nut member creates resistance to circular motion, thereby resisting rotation of the nut member and eliminating the requirement for lockwire to resist rotation of the nut member.

An embodiment of the coupling comprises a ferrule member, a connector member, and a nut member in cooperative engagement, wherein each of these components comprise axial passageways for passing fluid. The ferrule member is adapted at one end to receive and non-rotationally attach to a first fluid conduit. The other end of the ferrule member, identified herein as the first engagement end, has a sealing surface which, when the coupling is engaged, seals against an opposite facing sealing surface on the connector member. The ferrule member further comprises means for rotationally locking the nut member with respect to the ferrule member. Such rotational locking means may comprise a plurality of axially extending and circumferentially spaced serrations disposed between the end receiving the first fluid conduit and the engagement end.

The connector member is adapted at one end to receive a second fluid conduit. The opposite facing end of the connector, identified herein as the second engagement end, comprises a sealing surface which is adapted to seal against the first sealing surface of the ferrule member. The connector member comprises fastening means disposed adjacent to the second engagement end.

The nut member internally receives the first engagement end of the ferrule member, the second engagement end of the connector member, and the rotational locking means of the ferrule member. The nut member comprises fastening means, such as threads, which are adapted to engage the fastening means of the connector member. When the nut member is fully made up with the connector member, the sealing surface of the ferrule member is brought into sealing engagement with the sealing surface of the connector member to prevent leakage across the seal. The nut member may further comprise cantilever members which provide a platform for locating locking means for engaging the serrations of the ferrule member. Between adjacent cantilever members are openings which may facilitate visual confirmation that the serrations of the ferrule member are engaged within the nut member thereby resisting the rotation of the nut member.

The locking means of the nut member may comprise at least one inwardly protruding lock engagement member disposed on a cantilever member, wherein the lock engagement member is adapted to engage the serrations of the ferrule member when the nut member is made up in full engagement with the connector member and the sealing surface of the ferrule member is brought into sealing engagement with the sealing surface of the connector member to prevent leakage across the seal.

### BRIEF DESCRIPTION OF THE DRAWINGS

FIG. 1 is a perspective view of an embodiment of the disclosed coupling.

FIG. 2 is a side view of an embodiment of the disclosed coupling.

FIG. 3 is a view from the connector end of an embodiment of the disclosed coupling.

FIG. 4 is a view from the b-nut end of an embodiment of the disclosed coupling.

FIG. 5 is an exploded view of an embodiment of the disclosed coupling.

FIG. 6 is a front view of an embodiment of the b-nut showing a possible configuration of the inwardly protruding lock engagement members.

FIG. 7 is perspective view of an embodiment of the disclosed coupling in an elbow configuration.

FIG. 8 is a sectional view of the embodiment shown in FIG. 7.

FIG. 9 is a view from the b-nut end of the embodiment shown in FIG. 7.

### DETAILED DESCRIPTION OF THE EMBODIMENTS

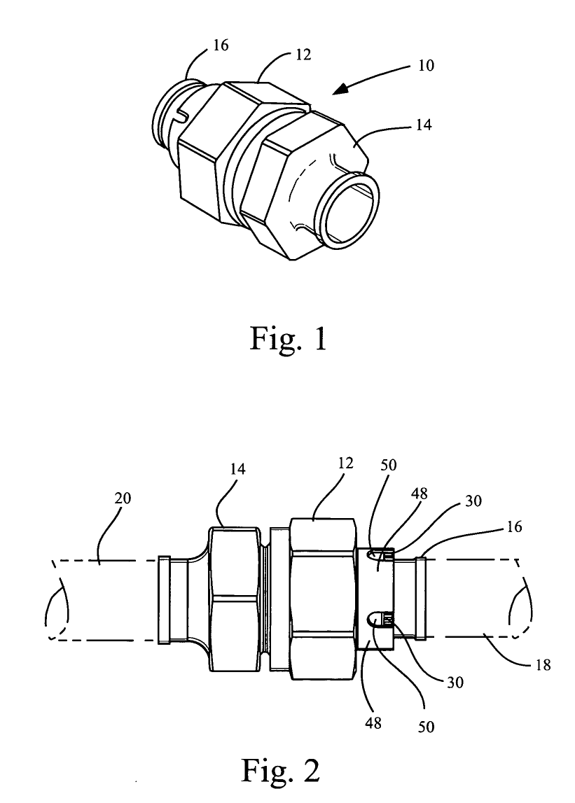

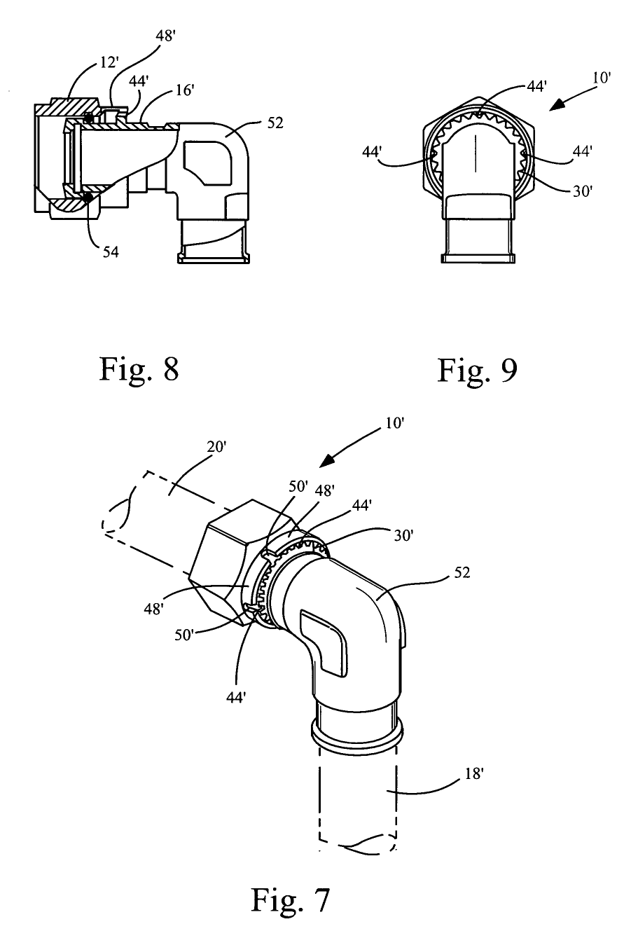

FIG. 1 shows the basic components of an embodiment of the disclosed coupling 10 in an assembled configuration, but shown without the connecting fluid conduits. The coupling 10 comprises a nut member 12, a connector member 14, and a ferrule member 16 which is only partially shown in FIG. 1. As shown in FIG. 2, the coupling 10 is utilized to connect fluid bearing conduit members which may be disposed in an opposite facing configuration as shown in FIG. 2, that is, where the fluid bearing conduit members are in axial alignment. An alternative embodiment, as shown in FIG. 7 through 9 may be utilized in which the fluid bearing conduit members are in a ninety-degree configuration.

First fluid conduit 18 is connected by the coupling 10 to a second fluid conduit 20. The second fluid conduit 20 is attached and sealed to connector member 14 by means known in the art, such as by welding, dynamic seal beam, flaring, flareless connection, crimping, swaging, lock ring, or other means known to those skilled in the art, which may utilize counter-bores, shoulders, or other internal structures within the connector member corresponding with the attachment means of the second fluid conduit 20.

The first fluid conduit 18 is likewise attached to ferrule member 16 and coupled with the nut member 12 such that the end of the ferrule member extends through the end of the nut member. The attachment means utilized for attaching ferrule member 16 to first fluid conduit 18 must not allow rotation of the ferrule member 16 with respect to the first fluid conduit 18. The coupling 10 must be configured such that when the coupling is made up to connect the two fluid conduits together, a leak-tight seal is created between a first seal face 22 of the ferrule member 16 and a second seal face 24 of the connector member 14. This type of seal, comprising a frusto-conical section in one seal face and matching surface in the opposing seal face is a dynamic seal wherein increased pressure of the fluid within the passageway works to increase the sealing force between the seal faces.

Ferrule member 16 is generally cylindrical, having an opening extending through its entire length, where the opening is oriented along the longitudinal axis of the ferrule member. The ferrule member 16 is adapted at one end, designated first end 26, to receive and non-rotationally attach to the first fluid conduit 18. The other end of the ferrule member 16, identified herein as the first engagement end 28, comprises first seal face 22. Ferrule member 16 further comprises rotational locking means for preventing the rotation of the nut member 12 once the nut member is made up to the connector member 14 and a leak-tight seal is created between the first seal face 22 of the ferrule member 16 and the second seal face 24 of the connector member 14. The locking means may comprise various interlocking structures located on the ferrule member 16 and the nut member 12 which engage once the nut member is fully made up to the connector member 14, such as a keyway and spline combination, or similar types of structures.

The locking means may also comprise, as shown in the Figures, a plurality of axially extending and circumferentially spaced serrations 30 disposed on the ferrule member 16 between the end 26 receiving the first fluid conduit 18 and the engagement end 28, wherein one or more inwardly protruding lock engagement members 44 of the nut member 12 engage the serrations 30. The serrations 30 may be configured such that the side of each serration facing the first engagement end 28 forms a right angle with respect to the longitudinal axis of the ferrule member 16 and the side of each serration facing the conduit receiving end 26 forms an angle of 45 degrees or less with respect to the longitudinal axis of the ferrule member.

While the number of serrations 30 may vary, it has been found that a configuration wherein the number of serrations varies from a range of 14 to 60 serrations circumferentially disposed about the ferrule member 16 is preferable. Ferrule member 16 may comprise various materials known to those practicing in the art, including plastics, composites, or high strength metal alloys, such as titanium.

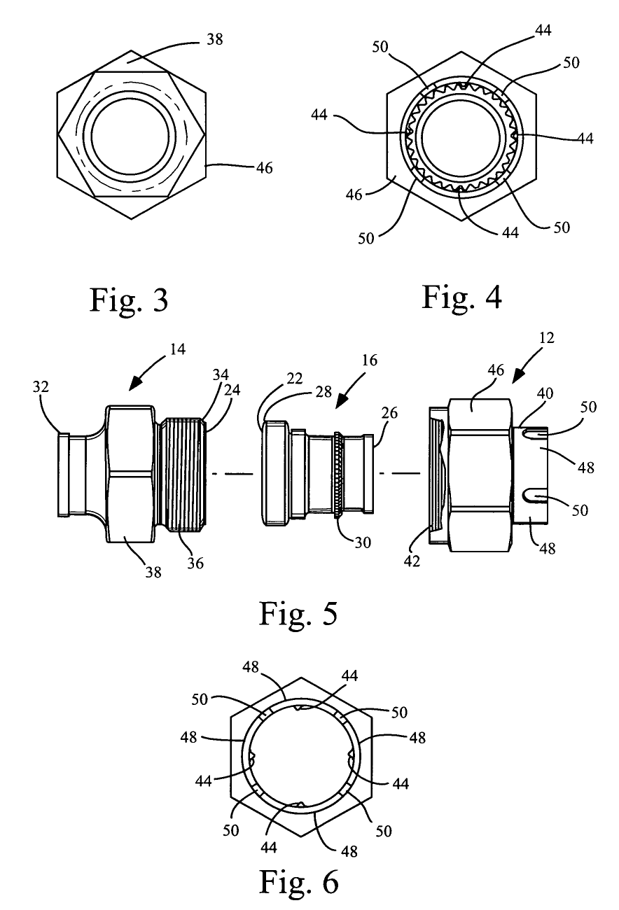

Connector member 14 comprises a second conduit receiving end 32 adapted to receive and attach to a second fluid conduit 20. Opposite second conduit receiving end 32 is second engagement end 34. Second engagement end 34 comprises a second seal face 24 which is adapted to seal against the first seal face 22 of the ferrule member 16. The connector member 14 further comprising fastening means, such as external threads 36 which are disposed adjacent to the second engagement end 34. As also shown in the figures, connector member 14 may comprise wrench flats 38 to facilitate making up the connector member 14 to the nut member 12. As shown in FIG. 3, the wrench flats 38 may be configured in a hexagonal profile.

Nut member (or B-nut) 12 makes up with connector member 14 such that as torque is applied to the nut member, the threads advance the nut member over the ferrule member 16 such that the nut member internally receives the ferrule member 16. When the nut member 12 is fully made up to the connector member 14, first end 26 of the ferrule member 16 extends out through sleeve 40 of the nut member. Nut member 12 further comprises fastening means, such as internal threads 42, which are adapted to engage the fastening means of the connector member 14, such as external threads 36, and make up the connection. When the nut member 12 is made up with the connector member 14, the first seal face 22 of the ferrule member 16 is brought into sealing engagement with the second seal face 24 of the connector member to prevent leakage across the seal.

When the nut member 12 is made up with the connector member 14, the first engagement end 28 of the ferrule member 16 and the second engagement end 34 of the connector member 14 will be internally received by the nut member. The nut member further comprises a plurality of cantilever members 48 which provide a beam for locking onto the serrations 30 of the ferrule member 16. The number of cantilever members may vary from three to eight, with four being the preferred number. As shown in FIG. 6, the nut member 12 further comprises one or more inwardly protruding lock engagement members 44 located on one or more of the cantilever members 48 wherein the inwardly protruding lock engagement member 44 is adapted to engage the serrations 30 of the ferrule member 16 when the nut member 12 is made up in full engagement with the connector member 14 and the first sealing face 22 of the ferrule member 16 is brought into sealing engagement with the second seal face 24 of the connector member 14. Between adjacent cantilever members are openings 50 which facilitate visual confirmation that the serrations 30 of the ferrule member 16 are engaged within the nut member 12 thereby resisting the rotation of the nut member 12.

As shown in the figures, nut member 12 may comprise wrench flats 46 to facilitate making up the nut member 12 to the connector member 14. As shown in FIGS. 3 and 4, the wrench flats 46 of the nut member 12 may be configured in a hexagonal profile.

While the disclosed coupling may be configured in a number of different dimensions, it has been found that when utilizing fluid conduits having an outside diameter ranging from 0.025 inch to 1.00 inch, a preferable range for the length of ferrule member 16 is from 0.695 inch to 0.760 inch. It has also been found that a preferable length dimension from the first end 26 to the plurality of axially extending and circumferentially spaced serrations 30 is approximately 0.20 inch, where the dimension is greater than 0.15 inch but not larger than 0.30 inch.

A preferable range of lengths of connector member 14 are 0.798 inch to 1.103 inch. A preferable range of lengths of nut member 12 are 0.679 inch to 1.020 inch.

FIGS. 7 through 9 show an alternative embodiment of the coupling 10′ which show the nut member 12′ attached to an elbow assembly 52, where ferrule member 16′ has serrations 30′. Lock engagement members 44′ engage serrations 30′ of the ferrule member 16′, thereby resisting the rotation of the nut member 12′. Clip wire 54 retains the ferrule member 16′ within the nut member 12′ prior to making the nut member up to an opposite facing connector member 14 and second fluid conduit 20 (not shown), but does not prevent rotation of nut member 12′ to engage the threads of the connector member. In this embodiment the longitudinal axis of the first fluid conduit 18′ is at an angle of approximately ninety degrees of the longitudinal axis of the second fluid conduit 20′.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A fluid coupling assembly comprising:
a ferrule member adapted to be connected to a first fluid conduit, the ferrule member comprising a first conduit receiving end and a first engagement end, the first conduit receiving end adapted to receive a first fluid conduit and the first engagement end comprising a first sealing surface, the ferrule member further comprising a first rotational locking means axially disposed between the first conduit receiving end and the first engagement end;
a connector member comprising a second conduit receiving end adapted to receive a second fluid conduit and a second engagement end comprising a second sealing surface adapted to seal against the first sealing surface of the ferrule member, the connector member further comprising a first fastening means disposed adjacent to the second engagement end; and
a nut member which internally receives the first engagement end of the ferrule member, the second engagement end of the connector member, and the first rotational locking means of the ferrule member, the nut member comprising a second fastening means adapted to engage the first fastening means of the connector member, wherein the first sealing surface is brought into sealing engagement with the second sealing surface when the first fastening means is made up with the second fastening means, the nut member further comprising a second rotational locking means adapted to engage the first rotational locking means of the ferrule member when the first sealing surface is in sealing engagement with the second sealing surface.

2. The fluid coupling assembly of claim 1 wherein the first rotational locking means comprises a plurality of axially extending and circumferentially spaced serrations.

3. The fluid coupling assembly of claim 1 wherein the nut member comprises a plurality of axially extending cantilever members.

4. The fluid coupling assembly of claim 3 wherein at least one of the axially extending cantilever members comprises the second rotational locking means.

5. The fluid coupling assembly of claim 4 wherein the second rotational locking means comprises an inwardly protruding lock engagement member adapted to engage the first rotational locking means upon the engagement of the first fastening means with the 10 second fastening means.

6. The fluid coupling assembly of claim 3 wherein the nut member comprises visual confirmation openings between adjacent cantilever members.

7. The fluid coupling assembly of claim 1 which is adapted to connect the first fluid conduit and the second fluid conduit in axial alignment.

8. The fluid coupling assembly of claim 1 which is adapted to connect the first fluid conduit and the second conduit where the longitudinal axis of the first fluid conduit is at an angle of approximately ninety degrees to the longitudinal axis of the second fluid conduit.

9. The fluid coupling assembly of claim 3 wherein the nut member comprises at least three but no more than eight axially extending cantilever members.

10. The fluid coupling assembly of claim 9 wherein each of the axially extending cantilever members comprises an inwardly protruding lock engagement member.

11. The fluid coupling assembly of claim 2 wherein the ferrule member comprises at least 14 but no more than 60 axially extending and circumferentially spaced serrations.

12. The fluid coupling assembly of claim 1 wherein the first fastening means of the connector member are external threads and the second fastening means of the nut member comprise internal threads.

13. The fluid coupling assembly of claim 1 wherein the nut member comprises a plurality of wrench flats.

14. The fluid coupling assembly of claim 13 wherein the wrench flats of the nut member are configured in a hexagonal profile.

15. The fluid coupling assembly of claim 1 wherein the connector member comprises a plurality of wrench flats.

16. The fluid coupling assembly of claim 15 wherein the wrench flats of the connector member are configured in a hexagonal profile.

17. The fluid coupling assembly of claim 2 wherein the plurality of axially extending and circumferentially spaced serrations are configured such that the side of each serration facing the engagement end of the ferrule member forms a right angle with respect to the longitudinal axis of the ferrule member

18. The fluid coupling assembly of claim 2 wherein the plurality of axially extending and circumferentially spaced serrations are configured such that the side of each serration facing the first conduit receiving end forms no greater than a forty-five degree angle with respect to the longitudinal axis of the ferrule member.

19. A fluid coupling assembly comprising:
a ferrule member adapted to be connected to a first fluid conduit, the ferrule member comprising a first conduit receiving end and a first engagement end, the first conduit attachment end adapted to receive a first fluid conduit and the first engagement end comprising a first sealing surface, the ferrule member further comprising a plurality of axially extending and circumferentially spaced serrations disposed between the first conduit receiving end and the first engagement end;
a connector member comprising a second conduit receiving end adapted to receive a second fluid conduit and a second engagement end comprising a second sealing surface adapted to seal against the first sealing surface of the ferrule member, the connector member further comprising external threads disposed adjacent to the second engagement end; and
a nut member which internally receives the first engagement end of the ferrule member, the second engagement end of the connector member, and the serrations of the ferrule member, the nut member comprising internal threads adapted to engage the external threads of the connector member, wherein the first sealing surface is brought into sealing engagement with the second sealing surface as the internal threads of the nut member are made up onto the external threads of the connector member, the nut member further comprising axially extending cantilever members wherein at least one cantilever member comprises an inwardly protruding lock engagement member adapted to engage at least one of the circumferentially spaced serrations of the ferrule member when the first sealing surface is brought into sealing engagement with the second sealing surface.

20. A fluid coupling assembly comprising:
a ferrule member adapted to be connected to a first fluid conduit, the ferrule member comprising a first conduit receiving end and a first engagement end, the first conduit attachment end adapted to receive a first fluid conduit and the first engagement end comprising a first sealing surface, the ferrule member further comprising a plurality of axially extending and circumferentially spaced serrations disposed between the first conduit receiving end and the first engagement end, wherein the dimension from the first end engagement end to the plurality of axially extending and circumferentially spaced serrations is greater than 0.15 inch but not larger than 0.30 inch;
a connector member comprising a second conduit receiving end adapted to receive a second fluid conduit and a second engagement end comprising a second sealing surface adapted to seal against the first sealing surface of the ferrule member, the connector member further comprising external fastening means disposed adjacent to the second engagement end; and
a nut member which internally receives the first engagement end of the ferrule member, the second engagement end of the connector member, and the serrations of the ferrule member, the nut member comprising internal fastening means adapted to engage the external fastening means of the connector member, thereby bringing the first sealing surface into sealing engagement with the second sealing surface, the nut member further comprising axially extending cantilever members wherein at least one cantilever member comprises an inwardly protruding lock engagement member adapted to engage at least one of the circumferentially spaced serrations of the ferrule member when the first sealing surface is brought into sealing engagement with the second sealing surface.
